(19) United States
(12) Patent Application Publication
(10) Pub. No.: US 2005/0040254 A1
(43) Pub. Date: Feb. 24, 2005

(54) Multi-function and moveable fog-generator apparatus

(76) Inventor: Wen Chun Chang, Taipei (TW)

Correspondence Address: PERKINS COIE LLP, P.O. BOX 2168, MENLO PARK, CA, 94026, US

(21) Appl. No.: 10/671,821

(22) Filed: Sep. 25, 2003

(30) Foreign Application Priority Data
Aug. 19, 2003 (TW) 092122783

(51) Int. Cl. B05B 9/03; A62C 13/62; A62C 35/58

(52) U.S. Cl. 239/302; 239/550; 239/398

(57) ABSTRACT

The present invention discloses a multi-function and moveable fog-generator apparatus, comprising: a water tank, a mixture tank, a high pressure water pump, a power source, a plurality of hand water gun, a plurality of hand water gun storage box, a pipe roller and a handler, a plurality of changeable nozzle, a plurality of nozzle storage box, an anti-noise cover and a car. The fog-generator has four filters: inlet filter, outlet double layer filter, high pressure pipe filter and nozzle filter, to remove particles and solid materials to avoid blocking of the nozzle and to increase the life time of the pump. A special designed handler and pulling ring enable to transport rapidly to the field of application. Nozzle quick exchanging plug make it to change the nozzle quickly. The multi-nozzle design increases the quantity of fog, and thus increases working efficiency. The fog-generator can be used as fog extinguishing, foam extinguishing, car washing, building washing, swimming pool washing, floor washing, oil contamination removing, sprinkling, insecticide sprayer and cooling with fog to decrease temperature, etc.

### BACKGROUND OF THE INVENTION

1. Field of the invention

The present invention relates to the structure of a fog-generator, In particular, the present invention relates to the improvement of a multi-function and moveable fog-generating apparatus, which is suitable for the applications such as extinguishing, cleaning, foam extinguishing, foam cleaning, cooling and sprinkling, etc.

2. Description of the Related Art

Generally a fog-generator sprays droplet water from a nozzle under the pressure supplied by a pump. They are used for one purpose only. Such as the pending Germany patent application No.EX18666, which has many types such as a 4-wheel type, like a cart, can be pulled by manpower and moved slowly. Another type is installed on a handbarrow, carried by two or more persons, lay aside in a fixed position such as a fire fighting truck or working site easily to get fire accident. This type cannot move easily to the place an accident take place.

FIG. 1 is a block diagram of the structure of a fog extinguisher of the prior art. The water tank 102 stores a definite amount of water, for example, a 100-liter large tank. There is an inlet pipe 104 in the top or in one side of the tank. Pump 106 is driven by a small engine or a motor 108 to produce high pressure of water, water is ejected from nozzle 110 via water pipe 112. This type of fog-generator is used for extinguishing only. The drawback is too expensive, and the nozzle structure is so delicate that it would be blocked by particles and become inactive, especially not in use for a long time (always so, because fire accident do not occur frequently), it is easily to become rusty or blocking, and cannot be used in emergency. Other washing apparatus such as car washer or floor washer are very different from the extinguisher in nozzle and overall structure of the apparatus. The car washer mainly uses a strong water column or water drops to wash a car, do not use a special nozzle to form droplet. The simple structure and the nozzle are not suitable for extinguishing. Examples such as the Kranle product of a Germany company, the product in a catalogue of Interpump group of an Italian company and other commercial available car washer.

Besides, the foam extinguisher uses corrosiveness chemical to form a large quantity of foam for fire extinguishing, it hurts persons, delicate instruments, computers or electric equipments. Although it can put out of a fire, but cleaning after firing, hurting human and animals become its defects.

A fog-generator, which is moveable easily and has multi-function, is not available in the prior art. What is needed is an improved apparatus, which is moveable easily and multi-functional. In peacetime, there is no fire accident to be put out, the apparatus could be used for car washing, floor washing, wall of a building washing, swimming pool washing, sprinkling, insecticide spraying and cooling with fog to decrease temperature, etc. Through operating of the apparatus every day, the operation became accustom to the user, thus prevent the miss-operation or loss efficiency of the apparatus in emergency.

### OBJECTS OF THE INVENTION

It is therefore an object of the invention to provide an multi-function and moveable fog-generating apparatus, can be used for fog-extinguishing, foam extinguishing, fog car washing, foam car washing, building washing, swimming pool washing, floor washing, oil sludge washing to remove grease, sprinkling, insecticide spraying and cooling with fog to decrease temperature, etc.

It is another object of the invention to provide a multi-function and moveable fog-generating apparatus, installed in a cart with large twin wheels and small wheel, with special designed handler and pulling ring, can be push or pull by manpower, pulling by a car or a motorcycle, or load on a car bring to its mobility, quickly move to the location of accident or washing site.

It is yet another object of the invention to provide a multi-function and moveable fog-generating apparatus, providing a inlet filter and a double layer filter of the outlet, then supply water to pump, the high pressure water is then come to a pipe filter, finally go to a nozzle filter in the nozzle at the end of the piping, wherein the water go through four stages of filter; Although the nozzle need not use filter in car washing, the water still go through three stages of filter, this filtering design can remove any particle and solid materials to avoid blocking of the nozzle and to increase the life time of the pump.

It is yet a further object of the invention to provide an multi-function and moveable fog-generating apparatus, the nozzle connecter is design for rapid changing of the nozzle according to different applications; a plurality of nozzle storage cabinet storing nozzles with multiple nozzle design to increase fog quantity both straight ahead and the two sides, thus increasing working efficiency.

It is another object of the invention to provide a multi-function and moveable fog-generating apparatus, The storage tank providing two inlet, a small quantity inlet providing inlet connector for injection of city water; a large quantity inlet can be poured directly from another tank or water source for emergency continuous use.

It is yet another object of the invention to provide a multi-function and moveable fog-generating apparatus, providing anti-noise cover to prevent too much noise.

It is yet a further object of the invention to provide a multi-function and moveable fog-generating apparatus, providing two water tanks, one water tank equips with float valve to prevent overflow; another is the mixture tank storing, for example, foaming agents, cleaning agent, fire extinguishing chemical, pyrethrum, etc., a valve between the two tanks control the conduction or isolation of the two tanks, providing the selection of pure water or mixing water.

### DISCLOSURE OF THE INVENTION

A first aspect of the present invention teaches a Another preferred embodiment of the present invention teaches a

### BRIEF DESCRIPTION OF THE DRAWINGS

The foregoing and other advantages of the invention will be more fully, understood with reference to the description of the best embodiment and the drawing wherein:

FIG. 1 (prior art) is a block diagram of the structure of a fog extinguisher.

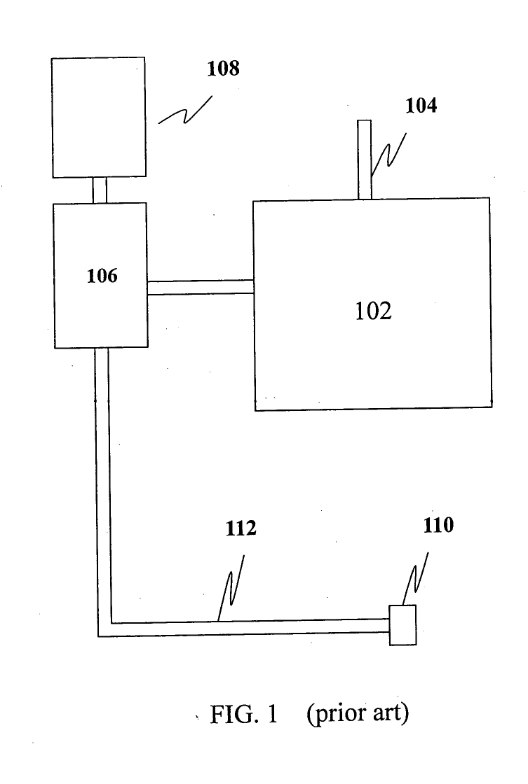

FIG. 2 is a block diagram of the structure of a multi-function fog-generator apparatus 200 in according to one embodiment of the present invention.

FIG. 3 is a multi-nozzle design in according to one embodiment of the present invention, (a) 2-nozzle design, (b) 3-nozzle design.

FIG. 4 is a schematic representation of the push-type multi-function fog-generator apparatus 300 in according to one embodiment of the present invention.

FIG. 5 is a schematic representation of the push-pull multi-function fog-generator apparatus 400 in according to one embodiment of the present invention.

FIG. 6 is a schematic representation of the man power push-pull multi-function fog-generator apparatus 500 in according to one embodiment of the present invention.

### DESCRIPTION OF THE PREFERRED EMBODIMENTS

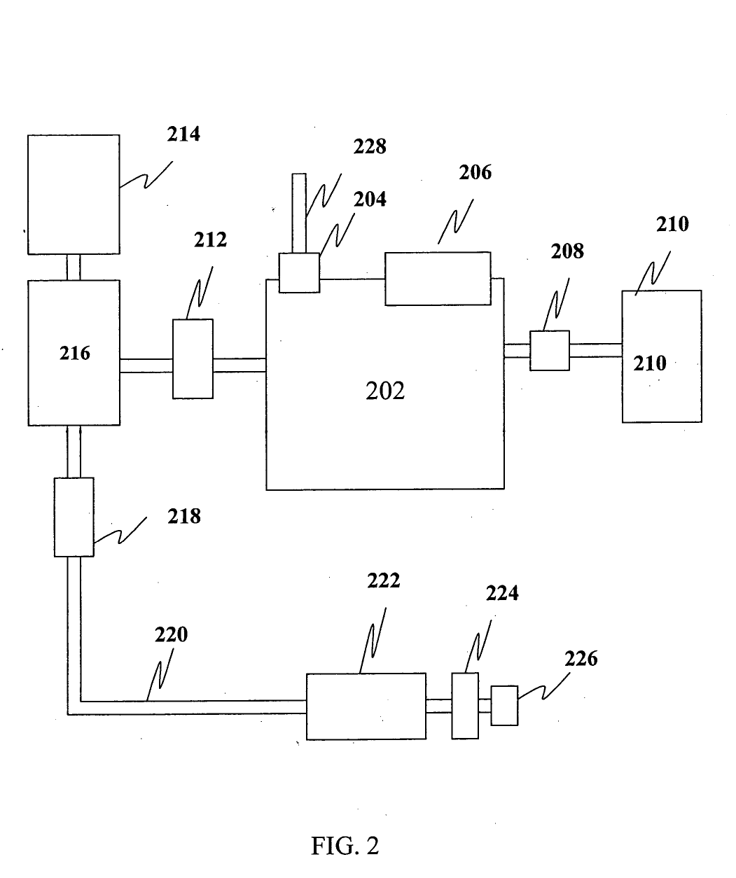

Referring to FIG. 2, FIG. 2 is a block diagram of the structure of a multi-function fog-generator apparatus 200 in according to one embodiment of the present invention. As shown in FIG.2, storage tank 202 includes a large quantity inlet and a filter 206; a small quantity inlet and a filter 204, said small quantity inlet is supplying water by city water pipe 228, wherein a filter is installed to remove particles and solid materials to prevent wearing down the pressure source (e.g. pump 216) and increase the life-time of the pump, The cubic measure of said storage tank need not too large, for example, 30 liter to 80 liter is enough (the prior art needs more than 100 liter) to increase mobility. The storage tank equips with float valve to prevent overflow. On the top or at one side of the storage tank 202 is a mixture tank 210. The cubic measure of the mixture tank is smaller, e.g. 10 liter is enough. The mixture tank 210 is connecting to said storage tang 202 via a valve 208 and high pressure pipe. The valve is shut off if water is used to generate fog, the mixture would not enter the storage tank; the valve is open if mixture is needed, then mixture will enter the storage tank with a definite ratio to generate fog with mixture. Said mixture is, for example, foaming agent, cleaning agent, extinguishing chemical, pyrethrum, or bio surface-active agent in environmental protection, to increase quick extinguishing effect, remove oil sludge and grease, etc., this Agent is not poisonous, neutral, not irritant, not corrosive and no harm to human and environment, helping bio-decompose of oil, protein, and fat, very good for environmental protection. In order to go a step further to protect the pump 216, In the outlet of the storage tank 202 equips with a double layer filter 212 connecting with rapid connector (not shown) for changing the filter quickly. The water or mixed liquid is pressurizing by a pump 216 to form a high pressure of 80-bar to 150-bar, and supply a quantity of 5 liter to 20 liter per minute of water to each nozzle. The driving power comes from a power source 214. Said power source may be a small power engine (e.g. a diesel engine or a gasoline engine) for the use at some place where providing electricity is not conveniently, or using electric motor at a place where electricity is available decrease its weight and noise. To start the engine, hand starting or battery electrical starter can be used, or equipped with both. The high-pressure water or mixture is once again be filtrated by said high-pressure pipe filter 218 to remove particles generated by the pump. Through these three filters, the blocking of the precise nozzle can be avoided, and may increase the lifetime of the nozzle filter (not shown). By using said apparatus, a general car washer without using a nozzle filter may not block, and need not clean the nozzle frequently. Said high-pressure pipe filter 220 is flexible pipe and can be rolled on a pipe roller. The end of the pipe is the handle water gun 222. A fast connector 222 connects the water gun and the nozzle together. The fast connector 222 is design for rapid changing of the nozzle. In different purpose of use, changing of the nozzle would be faster. In one side of the storage tank there are a plurality of nozzle storage box (as describes bellow) storage nozzles for different purpose of use. Also equips with a long water gun and a short water gun for changing for a special purpose.

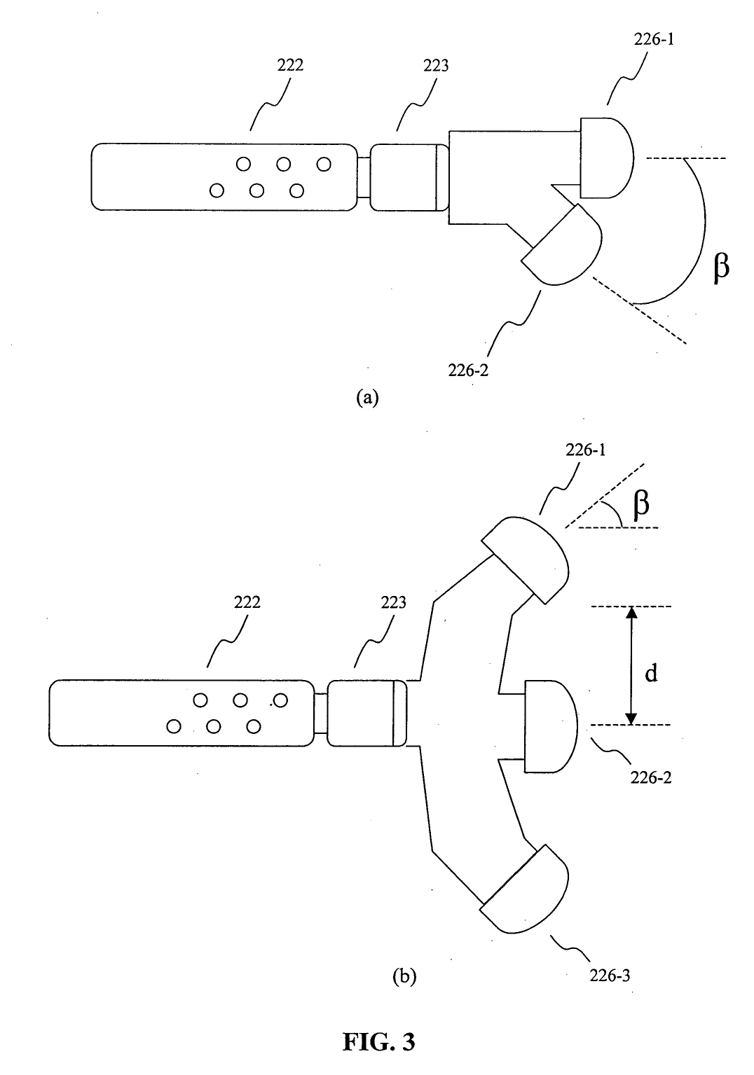

Refer to FIG. 3, FIG. 3 is a multi-nozzle design in according to one embodiment of the present invention, FIG. 3 (a) is a 2-nozzle design, FIG. 3 (b) is a 3-nozzle design. As shown in FIG. 3 (a), the multiple nozzle design of nozzle 226 has a main nozzle 226-1, spraying straightly ahead with stronger strength, but the coverage area is not wide enough. Another side-nozzle 226-2 spraying to one side with an angle of β, wherein β is between 15° to 60°, the better is 45°, to increase the quantity of fog, thus increasing working efficiency. One other embodiment of the present invention is shown in FIG. 3 (b), is a 3-nozzle design. A main nozzle 226-1, spraying straightly ahead with stronger strength, but the coverage area is not wide enough. By adding two side-nozzle 226-2 and 226-3, spraying to both side with an angle of β, wherein β is between 15° to 60°, the better is 45°, to increase the quantity of fog, thus increasing working efficiency.

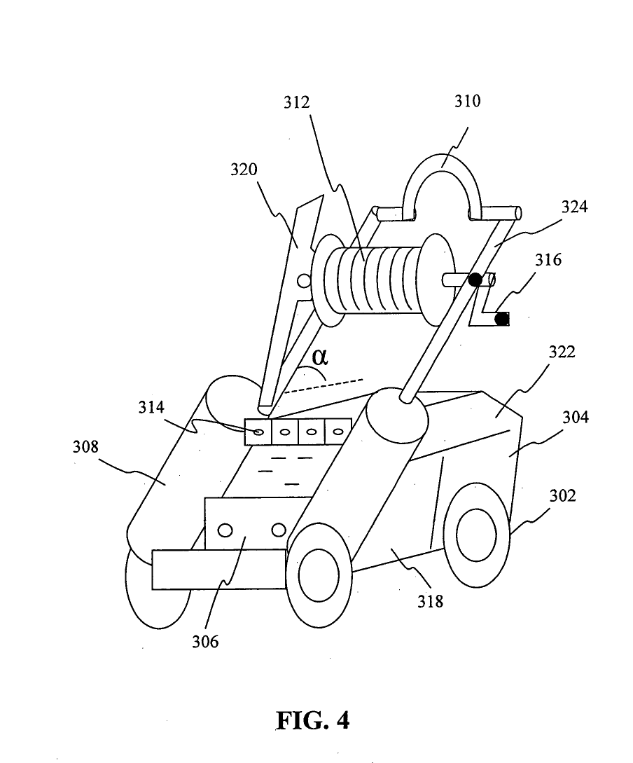

Refer to FIG. 4, FIG. 4 is a schematic representation of the push-type multi-function fog-generator apparatus 300 in according to one embodiment of the present invention. The fog-generator apparatus 300 is loading on a 4-wheel cart. Storage tank and mixture tank 318, engine or electric motor 304 and high-pressure pump 306 are placing on the cart. A plurality of water gun storage box 308 is placed in both side of the cart. A plurality of handled water gun is plug in the water gun storage box 308 in both sides. The number of the water gun storage box 308 and the handled water gun is the better of 1 to 4. A plurality of nozzle storage box 314 is used to store nozzles for different purpose of use. The number of the nozzle storage box 314 is the better of 3 to 5. A pulling ring 310 is connecting to a handler 324, handler 324 tilt backward with an angle of α, the angle of α is, for example, between 30° to 60° for pulling conveniently. Within the handler, there is a pipe roller 312, release or rolling up the pipe with a handler 316 for rolling the high-pressure pipe. The engine chamber equips with an anti-noise and prettified modeling cover 322. This type of fog-generator can be pulled by manpower.

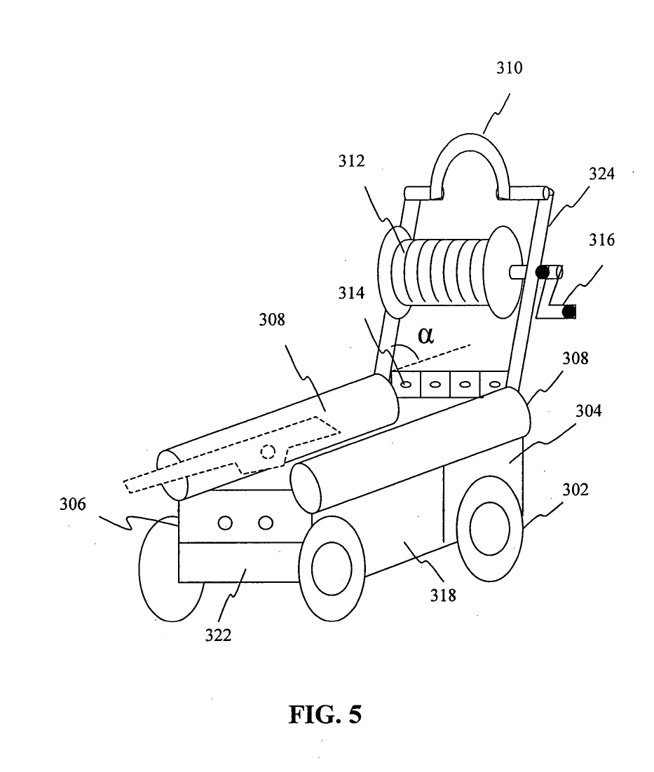

Refer to FIG. 5, FIG. 5 is a schematic representation of the push-pull multi-function fog-generator apparatus 400 in according to one embodiment of the present invention. The fog-generator apparatus 400 is loading on a 4-wheel cart. Storage tank and mixture tank 318, engine or electric motor 304 and high-pressure pump 306 are placing on the cart. A plurality of water gun storage box 308 is placed in both side of the cart. A plurality of handled water gun is plug in the water gun storage box. 308 in both sides. The number of the water gun storage box 308 and the handled water gun is the better of 1 to 4. A plurality of nozzle storage box 314 is used to store nozzles for different purpose of use. The number of the nozzle storage box 314 is the better of 3 to 5. A pulling ring 310 is connecting to a handler 324, handler 324 tilt backward with an angle of α, the angle of α is, for example, between 30° to 60° for pushing or pulling conveniently, and can be pull by a tractor to move quickly. Within the handler, there is a pipe roller 312, release or rolling up the pipe with a handler 316 for rolling the high-pressure pipe. The engine chamber equips with an anti-noise and prettified modeling cover 322. This push-pull type fog-generator can be pushed or pulled by manpower, or pull by a mobile or tractor to move quickly.

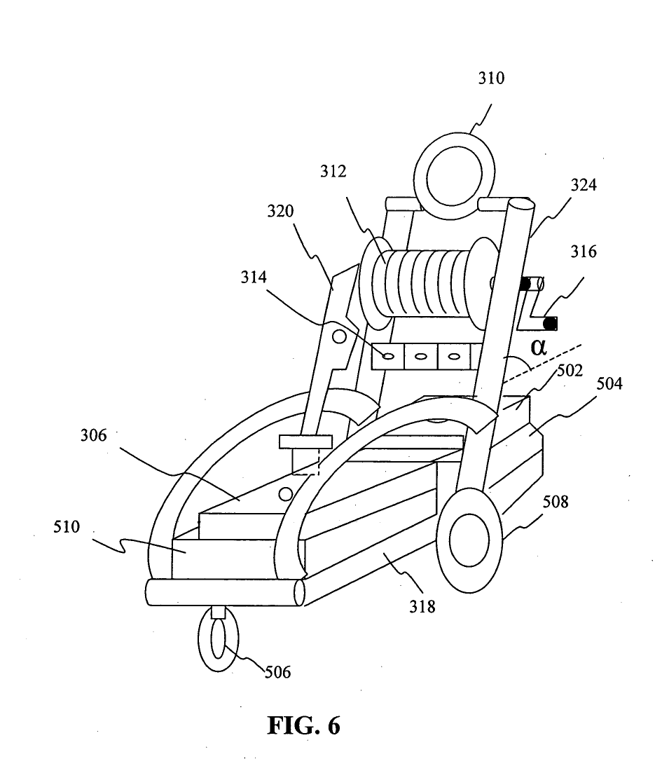

Refer to FIG. 5, FIG. 6 is a schematic representation of the man power push-pull multi-function fog-generator apparatus 500 in according to one embodiment of the present invention. The fog-generator apparatus 500 is loading on a 3-wheel cart with two rear wheels 508 and one smaller front wheel 506. Front wheel 506 can turn around freely for turning, forward backward, etc., Storage tank 518 mixture tank 510, fuel tank 502, engine or electric motor 504 and high-pressure pump 306 are placing on the cart. A plurality of water gun storage box 308 is placed in both side of the cart. A plurality of handled water gun is plug in the water gun storage box 308 in both sides. The number of the water gun storage box 308 and the handled water gun is the better of 1 to 4. A plurality of nozzle storage box 314 is used to store nozzles for different purpose of use. The number of the nozzle storage box 314 is the better of 3 to 5. A pulling ring 310 is connecting to a handler 324, handler 324 is connected to rear axis (not shown) and tilting backward with an angle of α, the angle of α is, for example, between 30° to 60° for pushing or pulling conveniently, and can be pull by a tractor to move quickly. Within the handler, there is a pipe roller 312, release or rolling up the pipe with a handler 316 for rolling the high-pressure pipe. The engine chamber equips with an anti-noise and prettified modeling cover 322. This 3-wheel push-pull type fog-generator can be pushed or pulled by manpower, or pull by a mobile or tractor to move quickly.

Although specific embodiments of the invention have been disclosed, it will be understood by those having skill in the art that minor changes can be made to the form and details of the specific embodiments disclosed herein, without departing from the spirit and the scope of the invention. The embodiments presented above are for purposes of example only and are not to be taken to limit the scope of the appended claims.

1. A multi-function and moveable fog-generating apparatus, comprising:
A storage tank, providing a small quantity inlet and a filter; a large quantity inlet and a filter; an outlet equipped with a double layer filter; also equips with float valve to prevent overflow;
A mixture tank, connecting to said storage tank with a valve to supply or not supply mixture to said storage tank;
A high-pressure pump, connecting to said outlet filter of said storage tank to add pressure to the water or mixing water; the outlet of the pump equips with a high-pressure pipe filter;
A power source, providing power to said high-pressure pump;
A plurality of handle water guns, connecting with high-pressure pipe to said high-pressure pump via said high-pressure pipe filter, the front end equipped with a fast connecter for conveniently changing of a nozzle;
A plurality of handle water gun storage-boxes, for placing said handle water gun;
A pipe roller and a handler, for rolling the pipe or releasing the pipe;
A plurality of changeable nozzles, said nozzle is one or multiple nozzle design, to increase the out going quantity of fog water, and providing fog water to both straight ahead and the two sides for different purpose of use; and equip with a filter at the end side;
A plurality of nozzle storage-box, for placing said nozzles;
A anti-noise cover, preventing too much noise of said power source;
A cart, for installing said storage tank, said mixture tank, said power source,, said high-pressure pump, said water gun, said water gun storage-boxes, said nozzles, said nozzle storage-boxes, said pipe and said roller, etc., equipped with front wheels and rear wheel(s), handler and pulling ring, for pushing or pulling said apparatus.

2. An apparatus as recited in claim 1, wherein the cubic measure of said storage tank is 30 liter to 80 liter.

3. An apparatus as recited in claim 1, wherein the cubic measure of said mixture tank is less than 10 liter.

4. An apparatus as recited in claim 1, wherein said high-pressure pump providing a pressure of 80 bar to 150 bar.

5. An apparatus as recited in claim 1, wherein said high-pressure pump supplying a quantity of 5 liter to 20 liter per minute of water to each nozzle.

6. An apparatus as recited in claim 1, wherein said power source is a small gasoline engine.

7. An apparatus as recited in claim 1, wherein said power source is an electric motor.

8. An apparatus as recited in claim 5, wherein said small gas engine is started by hand.

9. An apparatus as recited in claim 5, wherein said small gas engine is started by battery electric-starter.

10. An apparatus as recited in claim 5, wherein said small gas engine is started both by hand and electric-starter.

11. An apparatus as recited in claim 1, wherein said mixture is foaming agent.

12. An apparatus as recited in claim 1, wherein said mixture is cleaning agent.

13. An apparatus as recited in claim 1, wherein said mixture is fire extinguishing chemical.

14. An apparatus as recited in claim 1, wherein said mixture is pyrethrum.

15. An apparatus as recited in claim 1, wherein said mixture is bio surface-active agent in environmental protection.

16. An apparatus as recited in claim 1, wherein said handle water guns are 1 to 4

17. An apparatus as recited in claim 1, wherein said handle water gun storage-boxes are 3 to 5.

18. An apparatus as recited in claim 1, wherein every changeable nozzle has two nozzles, one spray straight ahead and the other one spray to one side with an angle of β, wherein β is between 15° to 60°, the better is 45°.

19. An apparatus as recited in claim 1, wherein every changeable nozzle has three nozzle, a central one spray straight ahead and the other two spray to the two side separate from said central one a distance of d apart with an angle of β, wherein d is between 5 cm to 10 cm and β is between 35° to 55°.

20. An apparatus as recited in claim 1, wherein said handler of the cart tilt backward with an angle of 30° to 60°.

21. An apparatus as recited in claim 1, wherein said cart can be pull by a car.

22. An apparatus as recited in claim 1, wherein said cart can be pull by a motorcycle.

23. An apparatus as recited in claim 1, wherein said cart can be pull by a tractor.

24. An apparatus as recited in claim 1, wherein said cart can be moved by push or pull with manpower.
